(19) United States
(12) Patent Application Publication
(10) Pub. No.: US 2008/0248906 A1
(43) Pub. Date: Oct. 9, 2008

(54) Tensioning System

(75) Inventor: Thomas Ullein, Frensdorf (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/064,470

(22) PCT Filed: Jul. 27, 2006
(86) PCT No.: PCT/EP06/07415

§ 371 Date: Mar. 4, 2008

(30) Foreign Application Priority Data
Aug. 23, 2005 (DE) 10 2005 039 740.9

(51) Int. Cl. F16H 7/08

(52) U.S. Cl. 474/110

(57) ABSTRACT

Hydraulic tensioning system for a flexible drive, in which a longitudinally displaceable piston guided in a housing is subjected to the force of a hydraulic fluid. For this purpose, the hydraulic fluid passes via a feed bore into a supply chamber of the housing. A portion of the hydraulic fluid is diverted via an injection nozzle of the housing for the purpose of acting on the flexible drive element.

### FIELD OF THE INVENTION

The invention relates to a hydraulic tensioning system for a traction mechanism, which is embodied in particular as a chain, of traction mechanism drives of an internal combustion engine. The tensioning system comprises a housing which is fastened in a positionally fixed manner to an internal combustion engine and forms a cylinder and in which is guided a piston which is acted on by a spring means and a hydraulic fluid. Here, the piston is operatively connected indirectly or directly to a tensioning rail which is guided on a traction mechanism. The hydraulic fluid for acting on the piston is conducted into the housing via a supply opening, with it being possible for a partial quantity of the hydraulic fluid to be utilized for the lubrication of the traction mechanism drive.

### BACKGROUND OF THE INVENTION

Such tensioning systems are used in order to ensure a sufficient pre-tension of the traction mechanism and oscillation-free drive. Known tensioning systems comprise a piston which is guided in a housing and which protrudes from the latter and which is operatively connected to a tensioning lever or a tensioning rail which is pivotably arranged on the housing of the internal combustion engine. The tensioning system brings about force-fitting sliding contact of the tensioning lever or of the tensioning rail against the traction mechanism. The construction provides that the tensioning system is assigned to the tensioning rail on the opposite side from the traction mechanism. The tensioning rail in connection with the tensioning system is preferably assigned to the traction mechanism in the region of the slack strand.

By way of example, DE 36 09 579 A1 presents a traction mechanism drive for an internal combustion engine in which the traction mechanism which is embodied as a timing chain is pre-tensioned by means of a tensioning rail. In the region of a bearing point of the tensioning rail, said tensioning rail has bores which are arranged offset with respect to one another and via which, in the operating state, a lubricant is supplied to the control chain in a targeted fashion. Said traction mechanism lubrication disadvantageously requires a high throughflow of the lubricant in order that all the spray bores can supply a sufficient quantity of lubricant to the control chain at the same time.

DE 36 39 389 A1 discloses a chain drive for an internal combustion engine in which the chain is pre-tensioned by means of a hydraulically actuated tensioning system. The construction of said known tensioning system comprises a housing which is filled with hydraulic fluid and in which a hollow cylindrical piston which is acted on with spring force is guided moveably. In the installed state, the piston is supported directly on a tensioning rail which is assigned to the slack strand of the traction mechanism drive. In the region of support of the piston against the tensioning rail, said tensioning rail has a bore which is dimensioned such that a spray oil quantity is conducted through the tensioning rail directly to the outer contour of the traction mechanism. Said measure serves, by means of targeted lubrication, to reduce the friction between the traction mechanism and the tensioning rail. This measure requires the formation of a special cylinder housing, and a correspondingly adapted tensioning rail.

### SUMMARY OF THE INVENTION

Taking into consideration the disadvantages of the known solutions, it is an object of the present invention to realize, by means of a cost-effective measure, a tensioning system with an internal pressure with which the preload of the traction mechanism can be reduced.

Said problem is solved by means of the features of claims 1 and 2 in that in the operating state, the hydraulic fluid passes into a reservoir of the housing via a supply opening, which is embodied as a throttle and from which reservoir a partial quantity is fed via a spray nozzle to the traction mechanism drive, in particular to the traction mechanism. By means of said measure according to the invention, the pressure of the hydraulic fluid for the supply, that is to say loading of the tensioning system can be reduced to an advantageously low pressure level. In this way, the functioning of the tensioning system is largely independent of the pressure level of the forced feed lubrication system of the internal combustion engine. The intentional reduction of the pressure of the hydraulic fluid by means of a corresponding design of the supply bore as a throttle also has no adverse effect on the functioning of the hydraulic element, which can also be referred to as a one-way valve, between the reservoir and the pressure space within the housing. Even in the case of a low supply pressure, the functioning of the hydraulic element and therefore the pressure loading of the piston is ensured. The reduced pressure of the hydraulic fluid, which at the same time reduces the pre-tension and consequently the wear of the traction mechanism, advantageously also improves the noise level.

The pressure of the hydraulic fluid is in a direct relationship with the operating state of the internal combustion engine and is therefore dependent in particular on the rotational speed and the temperature. In conventional tensioning systems, in the operating state, a pressure level of the hydraulic fluid arises which is considerably greater than the pressure required for the functioning of the hydraulic element. A high pressure of the hydraulic fluid increases the pre-tension of the tensioning system, together with the disadvantages of increased friction between the tensioning rail and the traction mechanism and an increased level of wear. In addition, a high pressure adversely affects the noise behavior of the traction mechanism drive. All of the above-specified adverse effects are largely eliminated by means of the invention by virtue of the tensioning system being acted on with a constant low pressure of the hydraulic fluid. The supply opening for the hydraulic fluid is advantageously formed directly as a throttle in the reservoir of the housing, with the cross section being selected such that the desired or required pressure is automatically set.

According to claim 1, an opening which is embodied as a spray nozzle is formed directly in the wall of the housing of the tensioning system, via which opening a partial quantity of the hydraulic fluid is utilized in a targeted fashion for acting on the traction mechanism drive. The hydraulic fluid is preferably conducted via the spray nozzle to the traction mechanism which is embodied as a chain, Said targeted lubrication of the traction mechanism results in an optimum friction value for example between the chain and the rail. Advantageously, no separate component is required to form the throttle and the spray nozzle. It is possible for both the supply opening which is embodied as a throttle and also the spray nozzle to be realized by means of a mechanical machining process. Said measures can be implemented in a cost-effective fashion, for example in the production of the housing, require no additional components and have no adverse effect on the assembly and the installation space of the tensioning system.

The invention as claimed in claim 2 comprises, in addition to a throttle formed directly in the wall of the housing via which hydraulic fluid passes into the reservoir, a separate component as a spray nozzle, which separate component is inserted into the wall of the housing.

Further advantageous embodiments of the invention are the subject matter of dependent claims 3 to 10.

In order to realize a cost-effective production of the supply opening and of the spray nozzle, bores are formed directly in the wall of the housing. In addition, the invention includes forming the bores for example so as to be inclined in order to thereby for example form a spray nozzle which ensures an optimum outlet of the hydraulic fluid out of the housing in the direction of the traction mechanism. The bores can be formed in the wall of the housing in a cost-effective manner by means of a simple mechanical reworking process. As an alternative to a bore, the invention also includes a geometric shape which deviates from a bore for the configuration of the supply opening and of the spray nozzle.

A tube piece which is inserted into the wall of the housing is preferably suited as a separate spray nozzle as claimed in claim 2. Depending on the installation situation, the tube piece which forms the spray nozzle can for this purpose be inserted obliquely in order to create a targeted outlet of the hydraulic fluid. The invention also includes a tube piece which is integrally connected to the wall of the housing.

It is also possible for curved tube pieces to be used as a spray nozzle, which curved tube pieces, when arranged correspondingly in the installed state, deflect the hydraulic fluid to the traction mechanism in a targeted fashion.

Further design features of the spray nozzle which is embodied as a tube piece relate to the spray nozzle outlet. A wide-area spray pattern of the hydraulic fluid is obtained with a spray nozzle in which the bore of the tube piece is widened in a conical fashion at the end side. Alternatively, a conical narrowing of the longitudinal bore of the tube piece permits a focused hydraulic fluid jet which acts on the traction mechanism in a targeted fashion over a greater distance.

The spray nozzle which is embodied as a bore can be formed in virtually all regions of the housing wall, Suitable for this purpose is inter alia the receiving dome for the fastening screw of the housing, in which receiving dome is formed a bore via which a partial quantity of the hydraulic fluid can emerge in a targeted fashion in the direction of the traction mechanism.

In order to obtain optimum operation of the tensioning system, a cross section of the spray nozzle is greater than the cross section of the supply opening. Said opening ratio results in a reduced pressure, which is however sufficient for the functioning of the tensioning system, of the hydraulic fluid in the reservoir of the housing. The reduced media pressure reduces the pre-tension of the tensioning system, which has a particularly advantageous effect on the wear of the tensioning rail. At the same time, a reduced noise level, as is demanded by many vehicle manufacturers, is generated.

It is also provided according to the invention that, in the installed position, the tensioning system is aligned such that the spray nozzle is always situated in a structurally higher position than the supply opening. Said arrangement prevents a complete outflow of the hydraulic fluid out of the reservoir or the gallery of the tensioning system. In this way, the hydraulic element which is embodied as a one-way valve is acted on by the hydraulic fluid constantly and the functioning of the tensioning system is thereby ensured.

### BRIEF DESCRIPTION OF THE DRAWINGS

Exemplary embodiments of the invention are illustrated in the drawings which are described below and in which:

FIG. 1 shows a perspective view of a traction mechanism drive in connection with a tensioning system;

FIG. 2 shows a system according to the invention in a section illustration which encompasses a spray nozzle integrated directly in the housing wall,

FIG. 3 shows a tensioning system as per FIG. 2, the spray nozzle of which is integrated in the region of a receiving dome;

FIG. 4 shows a tensioning system in which the spray nozzle is embodied as a separate component in the form of a tube piece;

FIG. 5 shows a further variant of a tensioning system, the spray nozzle of which encompasses a curved tube piece with a longitudinal bore which is narrowed at the end side.

### DETAILED DESCRIPTION OF THE DRAWINGS

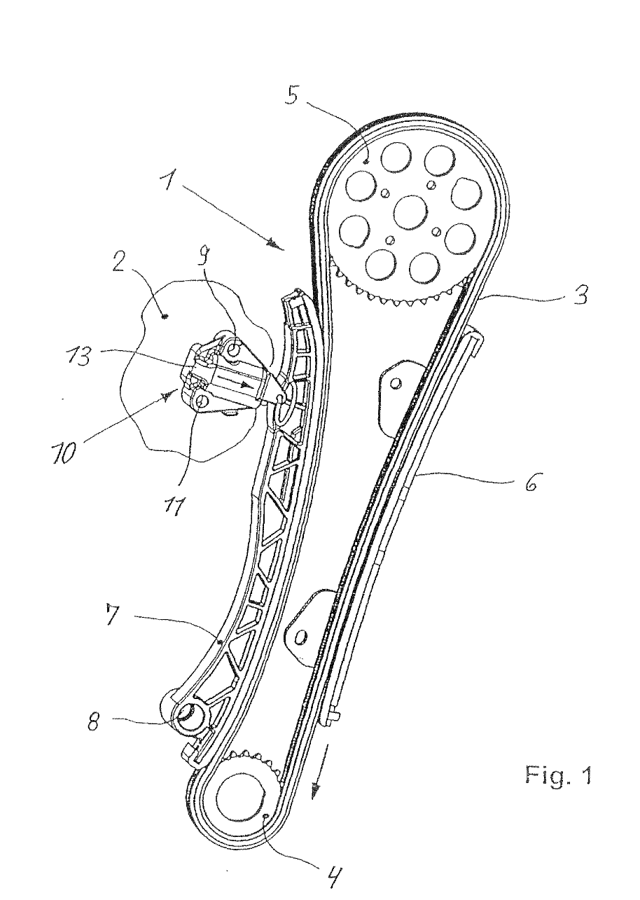

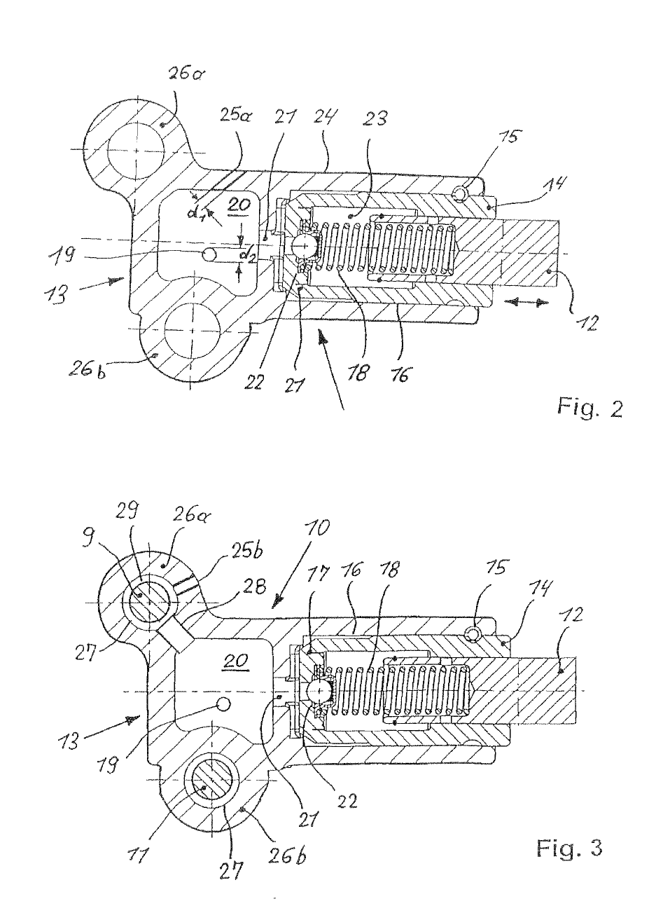

FIG. 1 illustrates a traction mechanism drive 1 of an internal combustion engine 2. Here, a traction mechanism 3 which is embodied as a chain connects a driven wheel 4, which is rotationally fixedly connected to a crankshaft of the internal combustion engine 2, to a driving wheel 5, by means of which a camshaft (not illustrated) of the internal combustion engine 2 is driven. The traction mechanism 3 which rotates clockwise is guided, in the region of a tension strand, on a guide rail 6. In addition, the traction mechanism 3 is, in the slack strand, operatively connected to a tensioning rail 7 which is arranged so as to be rotatable to a limited extent about a pivot axis 8. At the end remote from the pivot axis 8, the tensioning rail 7 is assigned a hydraulically acting tensioning system 10 which is detachably connected by means of fastening elements 9, 11, in particular screw connections, to the internal combustion engine 2. The tensioning system 10 is, in the operating state, acted on by a hydraulic fluid, in particular the lubricant of a forced feed lubrication system of the internal combustion engine 2. In this way, a piston 12 which is integrated in a housing 13 of the tensioning system 10 and which is inserted in a movable manner and which is depicted in FIGS. 2 to 5 is supported indirectly or directly on the tensioning rail 7. In order to obtain a sufficient pre-tension of the traction mechanism 3, the tensioning system 10, in the operating state, exerts a force acting in the direction of the arrow on the tensioning rail 7, as a result of which the latter is pivoted clockwise, that is to say in the direction of a position which pre-tensions the traction mechanism 3.

The section illustration as per FIG. 2 shows the construction of the tensioning system 10, in the housing 13 of which the piston 12 is guided in a longitudinally movable manner. The piston 12 is for this purpose inserted in a cylinder 14 which is fitted, so as to be rotationally secured and correctly positioned by means of a pin 15, in a receptacle 16 of the housing 13. Force-fitting contact of the piston 12 against the tensioning rail 7, regardless of the operating state of the internal combustion engine 2, is obtained by means of a spring means 18 inserted between a base 17 of the cylinder 14 and the piston 12. For the loading of the piston 12 by means of hydraulic fluid, the housing 13 is provided with a supply opening 19, via which the hydraulic fluid passes from the internal combustion engine 2 into a reservoir 20. From there, the hydraulic fluid is supplied via an activation bore 21 to a hydraulic element 22 embodied as a one-way valve, before the hydraulic fluid passes into the pressure space 23 which is delimited, at the opposite side from the base 17 of the cylinder 14, by the piston 12. An obliquely-arranged opening, in particular bore, is also formed in a wall 24 of the housing 13, which bore forms a spray nozzle 25a.

The object of the spray nozzle 25a is that of discharging a partial quantity of the hydraulic fluid entering into the reservoir 20 in order to thereby act on the traction mechanism 3, as a result of which the friction between the traction mechanism 3 and the tensioning rail 7 can be reduced. The oblique arrangement of the spray nozzle 25a in the wall 24 permits a targeted alignment of the hydraulic fluid, which preferably emerges from the spray nozzle 25a in the form of a jet, to the traction mechanism 3 depicted in FIG. 1. According to FIG. 2, the spray nozzle 25a is positioned in a higher position than the supply opening 19, as a result of which it is ensured that the reservoir 20 is always filled with hydraulic fluid. In addition, the tensioning system 10 comprises cross sections “d₁” and “d₂”, of the spray nozzle 25a and of the supply opening 19, which are of different dimensions to one another. Said components are preferably designed so as to give a ratio of <1 between the cross section “d₂” of the supply bore 19 and the cross section “d₁” of the spray nozzle 25a. Said cross-sectional ratio, in which the spray nozzle is intentionally designed to be larger, ensures a desired reduced pressure level of the hydraulic fluid within the reservoir 20.

FIGS. 3 to 5 show alternative designs of spray nozzles 25b to 25d, in each case in connection with the tensioning system 10 as per FIG. 2. The following parts of the description are consequently restricted to the design features which differ in relation to FIG. 2.

FIG. 3 shows the spray nozzle 25b which is formed in a receiving dome 26a of the housing 13. The housing 13 comprises two receiving domes 26a, 26b for the fastening elements 9, 11, in particular screw connections, which are in each case inserted with play into the bores 27 of the receiving dome 26. In the installed state of the tensioning system 10, the hydraulic fluid passes from the reservoir 20 via a branch bore 28 into the bore 27 of the receiving dome 26. The spray nozzle 25b is acted on via an annular gap 29 which is formed between the fastening element 9 and the receiving bore 27.

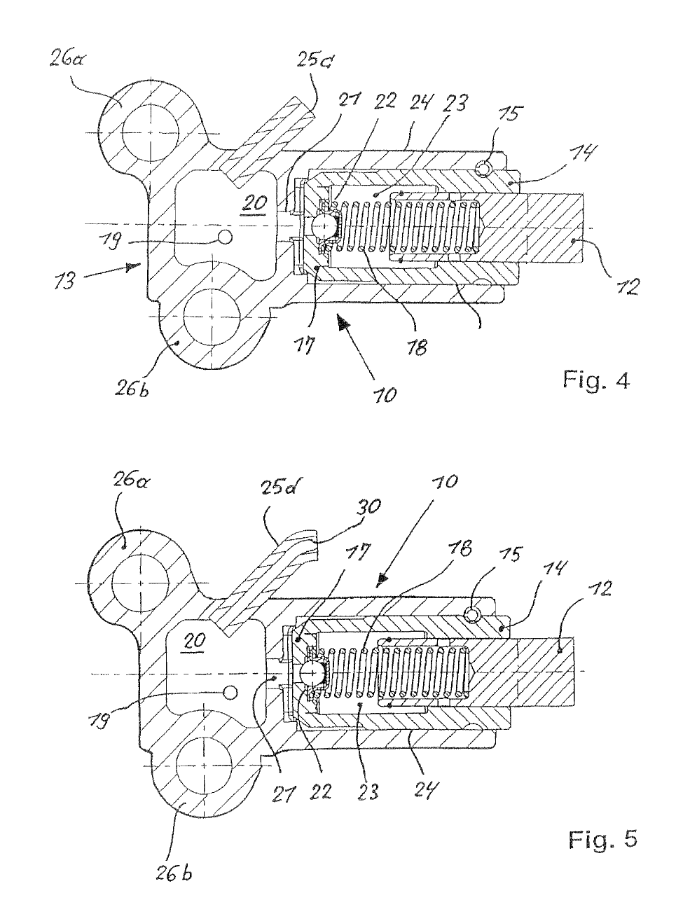

FIG. 4 shows the spray nozzle 25c, embodied as a tube piece, which is inserted obliquely into the wall 24 of the housing 13. By means of the tube piece, the hydraulic fluid which is intended for the traction mechanism 3 is conducted over a greater distance before emerging in order to act on the traction mechanism 3 in a targeted fashion.

The spray nozzle 25d as per FIG. 5 is curved at the end side in order to thereby for example ensure a targeted outflow of the hydraulic fluid out of the spray nozzle 25d. As a measure for, for example, bridging a greater distance between the outlet of the hydraulic fluid out of the spray nozzle 25d and the traction mechanism 3, the spray nozzle 25d is provided with a conical narrowing 30, as a result of which a focused fluid outflow is generated. As an alternative to the conical narrowing 30, a conical widening can likewise be used as a spray nozzle, by means of which a wide-area outflow of the hydraulic fluid can be obtained.

### LIST OF REFERENCE SYMBOLS

| | |
|---|---|
| 1 | Traction mechanism drive |
| 2 | Internal combustion engine |
| 3 | Traction mechanism |
| 4 | Driven wheel |
| 5 | Driving wheel |
| 6 | Guide rail |
| 7 | Tensioning rail |
| 8 | Pivot axis |
| 9 | Fastening element |
| 10 | Tensioning system |
| 11 | Fastening element |
| 12 | Piston |
| 13 | Housing |
| 14 | Cylinder |
| 15 | Pin |
| 16 | Receptacle |
| 17 | Base |
| 18 | Spring means |
| 19 | Supply opening |
| 20 | Reservoir |
| 21 | Activation bore |
| 22 | Hydraulic element |
| 23 | Pressure space |
| 24 | Wall |
| 25a | Spray nozzle |
| 25b | Spray nozzle |
| 25c2 | Spray nozzle |
| 25d | Spray nozzle |
| 26 | Receiving dome |
| 27 | Bore |
| 28 | Branch bore |
| 29 | Annular gap |
| 30 | Narrowing |
| d₁ | Cross section |
| d₂ | Cross section |

1. A hydraulic tensioning system for a traction mechanism, which is embodied in particular as a chain, of a traction mechanism drive of an internal combustion engine, comprising: a housing which is fastened in a positionally fixed manner to an internal combustion engine and forms a cylinder and in which is guided a piston which can be acted on by a spring means and a hydraulic fluid, which piston interacts indirectly or directly with a tensioning rail which is guided on a traction mechanism, with the hydraulic fluid entering into the housing via a supply opening, and a partial quantity of the hydraulic fluid being supplied, proceeding from the housing, to the traction mechanism, wherein in an operating state of the internal combustion engine, the hydraulic fluid passes by means of a supply opening, which is embodied as a throttle, into a reservoir of the housing, and a partial quantity of the hydraulic fluid flows to the traction mechanism drive or to the traction mechanism via a spray nozzle embodied as an opening in a wall of the housing.

2. A hydraulic tensioning system for a traction mechanism, which is embodied in particular as a chain, of a traction mechanism drive of an internal combustion engine, comprising: a housing which is fastened in a positionally fixed manner to an internal combustion engine and forms a cylinder and in which is guided a piston which can be acted on by a spring means and a hydraulic fluid, which piston interacts indirectly or directly with a tensioning rail which is guided on a traction mechanism, with the hydraulic fluid entering into the housing via a supply opening, and a partial quantity of the hydraulic fluid being supplied, proceeding from the housing, to the traction mechanism, wherein in an operating state of the internal combustion engine, the hydraulic fluid passes by means of a supply opening, which is embodied as a throttle, into a reservoir of the housing, and a partial quantity of the hydraulic fluid flows to the traction mechanism drive or to the traction mechanism via a spray nozzle embodied as a separate component inserted into the housing.

3. The hydraulic tensioning system of claim 1, wherein in order to form the supply opening and the spray nozzle, bores are formed directly in the wall of the housing.

4. The hydraulic tensioning system as of claim 2, wherein the tensioning system has a tube piece, which is inserted into the housing, as a spray nozzle.

5. The hydraulic tensioning system of claim 4, wherein the tensioning system has a curved tube piece, as a result of which the hydraulic fluid emerging from the spray nozzle acts on the traction mechanism in a targeted fashion.

6. The hydraulic tensioning system of claim 4, wherein a longitudinal bore of the tube piece is widened in a conical fashion at the end side.

7. The hydraulic tensioning system of claim 4, wherein the spray nozzle includes a longitudinal bore with a conical narrowing at the end side.

8. The hydraulic tensioning system of claim 1, wherein the spray nozzle is placed in the region of a screw-on dome for a fastening element to which the housing is fastened.

9. The hydraulic tensioning system of claim 1 or claim 2, wherein a cross section “d₁” of the spray nozzle exceeds a cross section “d₂” of the supply opening.

10. The hydraulic tensioning system of claim 1 or claim 2, an installation position is provided in which the spray nozzle is placed in a structurally higher position than the supply opening.
